(19) United States
(12) Patent Application Publication
(10) Pub. No.: US 2007/0035411 A1
(43) Pub. Date: Feb. 15, 2007

(54) Service selection

(75) Inventors: Janne Jalkanen, Helsinki (FI); Ilkka Känsälä, (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/201,858

(22) Filed: Aug. 10, 2005

(51) Int. Cl. H04Q 5/22

(52) U.S. Cl. 340/825.69; 340/10.1

(57) ABSTRACT

An electronic device for using wireless access modules such as RFID tags, which device has a wireless transponder access module capable of detecting a wireless transponder brought into the proximity of the device and of receiving information from wireless transponder, wherein the electronic device and the wireless transponder module are configured to provide a set of services when the wireless transponder is accessible to the wireless transponder access module. The electronic device contains a sensor that is capable of determining spatial information related to the access module and producing a corresponding spatial signal and a processor capable of selecting one service out of the set of services using the spatial signal. Hence, the way an RFID tag is swept close to the device determines the way in which the RFID tag should be used.

### FIELD OF THE INVENTION

This invention relates to selecting services. It relates particularly, but not exclusively, to selecting a service based on an RFID module.

### BACKGROUND OF THE INVENTION

RFID transponder tags allow tagging different goods, animals and even people for storage management, movement control and as keys, for instance. An RFID transponder receives electromagnetic radiation in response to which the RFID transponder (or tag) emits response signals. The response signal is typically unique for each RFID tag; hence the name Radio Frequency Identification. An RFID tag may be battery operated or excited by an electromagnetic field provided by an RFID reader so that even without a battery the RFID tag can emit back signals and even perform certain processing of data.

Modern RFID tags may provide different services and applications (hereafter commonly referred to as services) so that an RFID reader indicates by signaling which one of the services should be used. Such selection may be passed to an end user to make via a user interface connected to the RFID reader. An electronic device with a built-in RFID reader and user interface may readily allow a user to select a desired application from the RFID tag brought into a proximity of the RFID reader. In this way, the user typically has to follow choices presented on a display and respectively select a desired service with associated keys or using a pointing device.

### SUMMARY OF THE INVENTION

It is an objective of the invention to further simplify the selection of services using a wireless transponder.

According to a first aspect of the invention, an electronic device is provided, comprising:
a wireless transponder access module capable of detecting a wireless transponder brought into the proximity of the device and of receiving information from wireless transponder; wherein the electronic device and the wireless transponder module are configured to provide a set of services when the wireless transponder is accessible to the wireless transponder access module;
a sensor capable of determining spatial information related to the access module and producing a corresponding spatial signal; and
a processor capable of selecting one service out of the set of services using the spatial signal.

Advantageously, no key presses or pointer use is needed to select desired services. The service selection may be made with a single movement of bringing the wireless transponder and the access module to the proximity of each other so that the wireless transponder conforms to a predetermined spatial position, orientation or movement.

The spatial signal may be selected from a group consisting of: a motion signal, an orientation signal, a position signal, an acceleration signal, and a combination of any two of the said signals.

The set of services may be provided by the wireless transponder or by the electronic device.

The spatial signal may be determined in relation to one of the following references: the wireless transponder, a sensor mate element and the earth.

The sensor mate element may be attachable to a user or to the clothing of the user by a clip, button, Velcro tape, safety pin, elastic clamp, elastic band or hairpin. Advantageously, a sensor mate element attached to a user makes the spatial information use relative to the user herself, which is intuitive and independent of the user location.

Determining the spatial signal in relation to the earth is consistent to use and can be implemented with no need for any auxiliary equipment for detecting the relative motion, acceleration and/or orientation. Yet different services can easily and intuitively be selected by holding or moving the access module in different ways.

According to a second aspect of the present invention, there is provided a wireless transponder for providing selectable services, the transponder comprising:
a memory for storing a look-up table correlating two different spatial signals with respective services;
a sensor capable of determining spatial information related to the access module and producing a corresponding spatial signal; and
a processor for selecting a service corresponding to the spatial signal. Advantageously, a wireless transponder may comprise integrated spatial selection means so that a desired service can be selected without any other user interface and/or user interaction.

According to a third aspect of the present invention, there is provided a computer program capable of causing an electronic device to:
detect the proximity of a wireless transponder;
receive information from wireless transponder; wherein the electronic device and the wireless transponder module are configured to provide a set of services when the wireless transponder is accessible to the wireless transponder access module;
determine spatial information related to the access module and to produce a corresponding spatial signal; and
select one service out of the set of services using the spatial signal.

According to a fourth aspect of the present invention, there is provided a computer program capable of causing a wireless transponder to:
store a look-up table correlating two different spatial signals with respective services;
determine spatial information related to the access module and to produce a corresponding spatial signal; and
select a service corresponding to the spatial signal.

The wireless transponder of any one of the preceding aspects may be a Radio Frequency Identification (RFID) tag.

The access module may be integrated to the electronic device or connectable with a data connection selected from the group consisting of: a wired link and a wireless link.

The electronic device may be selected from the group consisting of: a portable device, a mobile device, a Personal Digital Assistant, a gaming device, a computer, a laptop computer, a tablet personal computer, a mobile communication device, a mobile telephone, a people presence monitoring device, a working time monitoring device, a GPS positioning device, an audio player, a video player and an assembly module for any of the preceding units.

According to a fifth aspect of the present invention there is provided a system including an electronic device according to the first aspect of the invention and a wireless transponder according to the second aspect of the invention.

According to a sixth aspect of the present invention, there is provided a method in an electronic device, including:
detecting the proximity of a wireless transponder;
receiving information from wireless transponder; wherein the electronic device and the wireless transponder module are configured to provide a set of services when the wireless transponder is accessible to the wireless transponder access module;
determining spatial information related to the access module and producing a corresponding spatial signal; and
selecting one service out of the set of services using the spatial signal.

According to a seventh aspect of the present invention, there is provided a method in a wireless transponder, including:
storing a look-up table correlating two different spatial signals with respective services;
determining spatial information related to the access module and producing a corresponding spatial signal; and
selecting a service corresponding to the spatial signal.

Various embodiments of the present invention have been illustrated only with reference to the one aspect of the invention for sake of briefness, but it should be appreciated that corresponding embodiments may apply to other aspects as well.

### BRIEF DESCRIPTION OF THE DRAWINGS

The invention will now be described, by way of example only, with reference to the accompanying drawings, in which:

FIG. 1 shows a block diagram of a mobile station (MS) and according to an embodiment of the invention;

FIG. 2 shows a block diagram of an RFID tag according to an embodiment of the invention; and

FIG. 3 shows a moveable mobile station or RFID tag and its different directions of motion or tilting.

### DETAILED DESCRIPTION

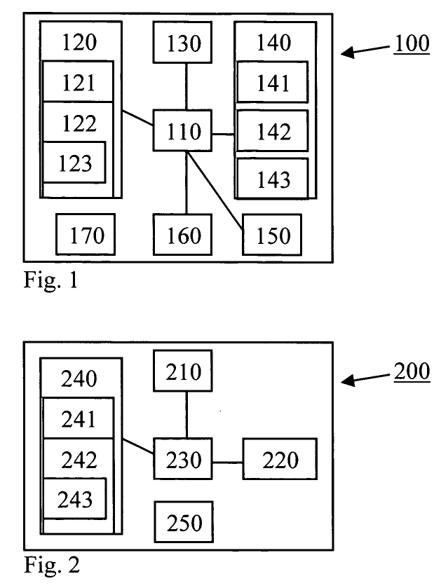

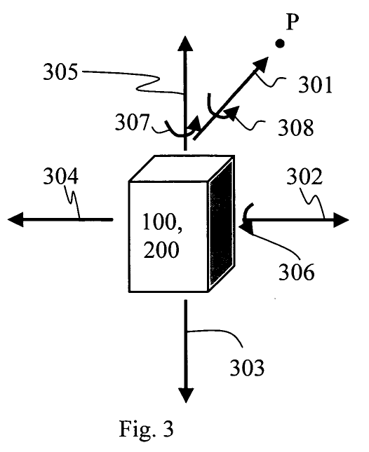

FIG. 1 shows a block diagram of a mobile station (MS) 100 according to an embodiment of the invention. The MS 100 comprises a processor 110, a memory 120, comprising a working memory 121 and a non-volatile memory 122, a Radio Frequency (RF) block 130, a user interface 140, a portable power supply 150 and a radio transponder access module 160 that is typically an RFID reader. The processor 110 controls operation of the MS 100. The portable power supply 150 energizes the MS 100. The MS 100 also contains, in an embodiment of the invention, a spatial sensor 170 for producing spatial information describing the position, orientation and/or motion of the MS 100. The use of this sensor is described with more detail referring to FIG. 3.

The processor 110 is typically a microprocessor or Digital Signal Processor. The working memory is typically Random Access Memory or flash-RAM. The non-volatile memory is typically Read Only Memory, mass memory, or flash-RAM. The non-volatile memory 122 contains computer executable program code 123 for controlling the processor 110 to run the MS 100 in a desired manner. The user interface 140 comprises keys, typically in form of a keyboard 141 or keypad, a display 142, and audio equipment 143 for audio signal input and/or output.

The access module 160 is configured to read and optionally write information from and to an RFID tag (shown in FIG. 2) using known technologies. Typically, the access module 160 emits in the normal operation low power radio waves and these radio waves excite and power the RFID tag sufficiently for the RFID tag to emit back its response signals detectable by the access module when sufficiently close to the RFID tag.

The aforementioned blocks and parts are merely examples and their equivalents may be used as well and some of the blocks and parts may be entirely omitted.

The processor controls the MS 100 to operate in accordance with embodiments of the present invention. The hardware, or the blocks of MS 100, are similar to those in prior art, but controlled by computer program code SW stored in the memory 120 (typically in the non-volatile portion 122) in order to implement the present invention.

FIG. 2 shows a block diagram of an RFID tag 200 according to an embodiment of the invention. FIG. 2 includes some features specific to an embodiment where the RFID tag 200 itself is configured to sense spatial information drawn with a dotted line. The RFID tag 200 contains a built-in antenna 210, radio block 220, processor 230, a memory 240 including a random access memory 241 and a non-volatile memory 242 containing computer program code 243 for controlling the processor 230. The RFID tag 200 further contains a battery 250 for implementing the non-volatile memory and/or for powering the circuitry of the RFID tag 200 so as to increase the distance over with the RFID tag 200 can be accessed with the access module 160. The battery can be omitted if the RFID tag 200 is powered by the radiation the access module 160 emits.

In both the MS 100 and in the RFID tag 200, the battery is connected to all power consuming components by power lines either directly or through other components such as voltage and/or current adapting circuits known from the art. Such lines are not drawn in FIGS. 1 and 2 to avoid unduly obscuring the drawings.

FIG. 3 shows a moveable mobile station 100 or RFID tag 200 and its different directions of motion or tilting. As FIG. 3 demonstrates the different spatial directions, it is equally applicable irrespective whether the mobile station 100 or the RFID tag 200 is a moved object.

On desiring to use an RFID tag, the user should move one or another of the RFID tag 200 and its access module 160 towards one another to enable RFID tag 200 use. When moving the moved object towards the other object indicated by point P in FIG. 3, the moved object should approach point P in direction 301, towards the point P. If no other, sideways, motion is made, then there are no sideways accelerations either. Alternatively, the user may move the moved object sideways to the right or left in direction 302 or 304, respectively, or vertically, in direction 303 or 305, respectfully. If point P is vertically offset from the moved object, then naturally none of the sideways directions are vertically oriented, but in sake of simplicity we may assume that point P is approximately in a common horizontal plane with the moved object.

In addition to the possibility of moved object being swept sideways in relation to point P, the moved object can also be rotated about any of the three Cartesian co-ordinate axels, in direction of arrows 306 to 308, respectively. Further, the moved object can be moved simultaneously in two or more of the directions (except opposite directions). The moved object need not necessarily be moved in direction 301 towards point P at all; instead, the moved object may be moved along any plane passing by the point P.

To distinguish different user choices whilst reading the RFID tag 200, the spatial information related to the moved object is utilized to distinguish one choice from another. For instance, if the moved object is an MS 100 and it is moved past a stationary RFID tag resting on a table, that is with a movement in a horizontal plane, the MS 100 can detect acceleration in direction 302 and the deceleration on stopping the swiping movement with the sensor 170. In this case, the sensor 170 may comprise an acceleration detection sensor. Alternatively, a camera unit such as a charged couple cell based unit can provide a signal that the processor 110 can interpret, using technology known from image recognition, showing motion from left to right. On such a combined motion detection and RFID tag access, a first predetermined service can be selected. It is now easy to see, in light of the foregoing description, that the orientation of the moved device (MS 100 or RFID tag 200) can be combined to the movement. For instance, when moved from left to right over an RFID tag, the user can select a first service so that respective indication is displayed on the MS 100 UI display 142 for confirmation of the user. On the other hand, if the MS 100 is held 90 degrees tilted in one direction, the MS 100 may deduce that no separate confirmation is desired but instead the selected service should be instantaneously selected and provided. Further, it can be imagined that by tilting the MS 100 to one predetermined direction, the MS 100 may detect a given motion in relation to the RFID tag 200 as a command to undo a previously made selection. It is thus clear that the invention provides a host of possibilities to user interface design and enables a number of quick and intuitive services with just a move of a hand holding a moved device.

It is also possible for a user to move both the MS 100 and the RFID tag 200 simultaneously to cause a desired mutual motion detectable by either or both of the devices. As will be appreciated by a person skilled in the art, the orientation of a device can only be detected with a respective sensor and that to make use of the orientation of both the MS 100 and the RFID tag 200, should such an added source of variation be desired, typically requires separate orientation sensors or a common sensor capable of detecting the orientation of two devices simultaneously. The common sensor may be implemented by means of machine vision, for instance. Providing different surfaces of the RFID tag 200 and the MS 100 by different colors, shapes and textures facilitates such an implementation.

As to the sensing of the motion and/or orientation of the MS 100 and/or the RFID tag 200, the reference to which the motion or orientation is compared can be the gravitational field of earth or a dedicated reference provided by the remaining device or an additional reference device. For instance, one or more magnets, sound or electromagnetic radiation sources (lamps, for instance) may be placed about the moved device to enable the moved device deduce its spatial relationship with the additional reference device. It is also possible to use a sensor clothing that detects the motion of the user's own hand that holds the moved device so as to detect the motion of the device itself. In order to obtain the motion information from any externally located motion sensing device, a communication link, advantageously wireless communication link, is provided between the externally located motion sensing device and the MS 100, possibly via the RFID tag 200.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. A number of features were described as part of examples in the foregoing and wherever technically possible, the features should be regarded as optional and combinable with any different other examples of the description. For instance, the functionality of the electronic device of using a wireless access module in a manner dependable upon the way the access module moves in relation to the electronic device can be implemented using an assembly module which incorporates all or most of the relevant components. The assembly module can be an electronics chip or a circuit board comprising one or more electronic circuitries. Hence, the scope of the invention is only restricted by the attached patent claims.

We claim:

1. An electronic device, comprising:
a wireless transponder access module capable of detecting a wireless transponder brought into the proximity of the device and of receiving information from wireless transponder; wherein the electronic device and the wireless transponder module are configured to provide a set of services when the wireless transponder is accessible to the wireless transponder access module;
a sensor capable of determining spatial information related to the access module and producing a corresponding spatial signal; and
a processor capable of selecting one service out of the set of services using the spatial signal.

2. An electronic device according to claim 1, wherein the spatial signal is selected from a group consisting of: a motion signal, an orientation signal, a position signal, an acceleration signal, and a combination of any two of the said signals.

3. An electronic device according to claim 1, wherein the set of services is provided by the wireless transponder or by the electronic device.

4. An electronic device according to claim 1, wherein the spatial signal is determined in relation to one of the following references: the wireless transponder, a sensor mate element and the earth.

5. An electronic device according to claim 4, wherein the sensor mate element is attachable to a user or to the clothing of the user by a clip, button, Velcro tape, safety pin, elastic clamp, elastic band or hairpin.

6. An electronic device according to claim 1, wherein the wireless transponder is a Radio Frequency Identification (RFID) tag.

7. An electronic device according to claim 1, wherein the access module is integrated to the electronic device or connectable with a data connection selected from the group consisting of: a wired link and a wireless link.

8. An electronic device according to claim 1, wherein the electronic device is selected from the group consisting of: a portable device, a mobile device, a Personal Digital Assistant, a gaming device, a computer, a laptop computer, a tablet personal computer, a mobile communication device, a mobile telephone, a people presence monitoring device, a working time monitoring device, a GPS positioning device, an audio player and a video player, and an assembly module for any of the preceding units.

9. A wireless transponder for providing selectable services, the transponder comprising:
a memory for storing a look-up table correlating two different spatial signals with respective services;
a sensor capable of determining spatial information related to the access module and producing a corresponding spatial signal; and
a processor for selecting a service corresponding to the spatial signal.

10. A wireless transponder according to claim 9, wherein the wireless transponder is a Radio Frequency Identification (RFID) tag.

11. A system including an electronic device and a wireless transponder, the electronic device comprising:
a wireless transponder access module capable of detecting a wireless transponder brought into the proximity of the device and of receiving information from wireless transponder; wherein the electronic device and the wireless transponder module are configured to provide a set of services when the wireless transponder is accessible to the wireless transponder access module;
a sensor capable of determining spatial information related to the access module and producing a corresponding spatial signal; and
a processor capable of selecting one service out of the set of services using the spatial signal; and the wireless transponder comprising:
a memory for storing a look-up table correlating two different spatial signals with respective services;
a sensor capable of determining spatial information related to the access module and producing a corresponding spatial signal; and
a processor for selecting a service corresponding to the spatial signal.

12. A computer program capable of causing an electronic device to:
detect the proximity of a wireless transponder;
receive information from wireless transponder; wherein the electronic device and the wireless transponder module are configured to provide a set of services when the wireless transponder is accessible to the wireless transponder access module;
determine spatial information related to the access module and to produce a corresponding spatial signal; and
select one service out of the set of services using the spatial signal.

13. A computer program capable of causing a wireless transponder to:
store a look-up table correlating two different spatial signals with respective services;
determine spatial information related to the access module and to produce a corresponding spatial signal; and
select a service corresponding to the spatial signal.

14. A method in an electronic device, including:
detecting the proximity of a wireless transponder;
receiving information from wireless transponder; wherein the electronic device and the wireless transponder module are configured to provide a set of services when the wireless transponder is accessible to the wireless transponder access module;
determining spatial information related to the access module and producing a corresponding spatial signal; and
selecting one service out of the set of services using the spatial signal.

15. A method in a wireless transponder, including:
storing a look-up table correlating two different spatial signals with respective services;
determining spatial information related to the access module and producing a corresponding spatial signal; and
selecting a service corresponding to the spatial signal.
